(19) United States
(12) Patent Application Publication
(10) Pub. No.: US 2026/0339619 A1
(43) Pub. Date: Oct. 29, 2026

(54) METHOD AND APPARATUS FOR CREATING A CONTROL LOGIC OF AT LEAST ONE COMPONENT

(71) Applicant: SICK AG, Waldkrich (DE)

(72) Inventors: Richard JAHNER, Umkirch (DE); Daniel BRUNO, Lörrach (DE)

(21) Appl. No.: 19/655,641

(22) Filed: Apr. 22, 2026

(30) Foreign Application Priority Data
Apr. 23, 2025 (EP) 25172001.7

(51) Int. Cl. G06F 8/30; G06F 16/3329

(52) U.S. Cl. CPC G06F 8/30; G06F 16/3329

(57) ABSTRACT

A method for creating a control logic of at least one component comprises: transmitting component description data to a large language model, wherein the component description data describe the at least one component; transmitting logic description information to the large language model, wherein the logic description information has information with respect to the control logic to be created; and instructing the large language model to create the control logic based on the component description data and the logic description information.

The invention relates to methods and apparatus for creating a control logic of at least one component. The components can include one or more sensors and/or one or more actuators.

IO—(input/output) Link is a standardized, manufacturer-independent communication interface for sensors and actuators in automation technology. It enables the bidirectional point-to-point communication between a control system and a field device, which enables a simple parameterization, diagnosis and an efficient transmission of process data.

An IO-Link master is the link between the IO-Link devices (e.g. sensors or actuators) and the higher-level automation system (e.g. PLC or IoT platforms). It coordinates the communication, collects the data from the connected IO-Link devices and transmits said data further, often via a fieldbus such as Profinet or EtherNet/IP. Furthermore, the IO-Link master plays an important role in IoT applications since it can forward data to cloud systems or IoT systems via protocols such as MQTT or OPC UA. The IO-Link master thus acts as a gateway to both the classic control level and the modern IoT infrastructure.

A logic editor is a software application or a tool that is used to graphically create and edit control logic. It makes it possible to define logical sequences using symbols and/or graphic modules and/or logical links (e.g. AND, OR, timer) without a text-based programming being required for this purpose. Even complex control tasks can thereby be created and visualized in an intuitive manner, which facilitates the development and testing of automation solutions. Logic editors are often used in industrial automation to configure controls and devices (in other words: components).

Usually, when configuring IO-Link master gateways, provision is made that either graphical logic editors or logics programmed directly in programmable logic controllers (PLCs) are used to create logical links and control tasks. These methods require special technical knowledge, in particular when using PLCs, where the writing and testing of program code is necessary. Logic editors that are used in industrial automation environments indeed offer a visual interface, but the complexity of the logic definition remains. The entry hurdle for a logic editor is indeed not particularly high, but users must have knowledge of number formats and logical links and must be able to break down the target application into small logic operations, which is not always easy. Furthermore, the interaction takes place predominantly via user-defined interfaces that do not support a natural language processing and are thus not intuitive to use. This leads to a time-consuming creation and adaptation of control logics.

Logic editors can be used with the SIG200 or SIG300, for example.

The use of conventional logic editors and PLC programming requires specialized technical knowledge that not every user has. This limits the accessibility for less experienced users and increases the training effort. Furthermore, the processes for creating and adapting the control logic are time-consuming, in particular if complex links have to be created manually. In addition, there is a high susceptibility to errors since users have to define the logics in small steps and without support by natural language processing. This often leads to misconfigurations and an increased need for tests and corrections. Working with a PLC also requires additional hardware and software, which leads to additional costs. Finally, the available interfaces for creating the logic are often not intuitive and require detailed knowledge of the underlying system structure, which limits the efficiency and flexibility of the automation solutions.

It is the object of the invention to reduce the complexity and the high effort when creating logical links and control logics for IO-Link master gateways. Conventional logic editors or programming carried out directly in the programmable logic controller (PLC) require specialized knowledge and extensive manual configuration work, which limits the accessibility and increases the susceptibility to errors. This in particular poses a challenge for users without in-depth programming knowledge.

The object is satisfied by a method having the features of claim 1, an apparatus having the features of claim 14, and a computer readable storage medium having the features of claim 15.

A method according to the invention for creating a control logic of at least one component comprises: transmitting component description data to a large language model, wherein the component description data describe the at least one component; transmitting logic description information to the large language model, wherein the logic description information has information with respect to the control logic to be created; and instructing the large language model to create the control logic based on the component description data and the logic description information.

The method in particular provides interfaces for transmitting component description data to a large language model, wherein the component description data describe the at least one component; for transmitting logic description information to the large language model, wherein the logic description information has information with respect to the control logic to be created; and for instructing the large language model to create the control logic based on the component description data and the logic description information.

In other words, an LLM is provided to replace (or substitute) a logic editor in IO-Link master gateways.

A large language model (LLM) is an artificial neural network that has been trained to understand and generate language. It uses large amounts of text data to recognize patterns and correlations in the language and to generate answers based thereon. These models work with a high number of parameters that enable the ability to process language at a high level.

In one embodiment, the component description data are transmitted in a prompt to the large language model. This transmission can take place with every instruction for creating the graphical interface. It is therefore not necessary to train the large language model specifically with the component description data. A standard large language model can therefore be used.

In one embodiment, input data are transmitted to the LLM as prompt components. The input data can comprise a system prompt, a user prompt and context data.

The system prompt can comprise information about the following: available logic modules and/or supported interfaces and data types, and/or basic system parameters.

The user prompt can comprise information about the following: natural language description of the desired logic, and/or indication of devices, connections and conditions, and/or specification of value ranges and transformations.

The context data can comprise information about the following: IODD information of the devices involved and/or gateway configuration and available resources and/or connection and interface assignment.

The component description data can be based on a device description. For example, the device description can be an IO (input/output) device description (IODD).

In one embodiment, the device description can be divided into a plurality of snippets. A snippet can in this respect be understood as a (short) excerpt or a summary from a larger text. This makes it possible to divide the device description, which can be very large, into smaller parts. A further reduction in the size of the data to be transmitted to the LLM can be achieved by calculating embeddings of the plurality of snippets and using the embeddings as component description data.

Embeddings can be mathematical representations of words, sentences or other data points in a continuous vector space. Due to embeddings, the text data of the device description or of the snippets can be brought into a form that has a reduced data volume and that is easier for the LLM to process. The embeddings can be generated by training processes in which a model processes large amounts of text data. During this training, the model learns to recognize semantic relationships between words and to encode them in vectors. For example, the embeddings can be generated using the following methods: Word2Vec, GloVe (Global Vectors for Word Representation), or BERT and GPT.

In one embodiment, information about available logic modules and/or supported interfaces and/or supported data types and/or basic system parameters is transmitted to the large language model.

The method can further include requesting the logic description information from a user. In this respect, the user can enter the desired logic in natural language and does not have to refer to details of the technical characteristics of the components. The use of the method is thereby also not possible for personnel with no training or less training.

The method can further comprise obtaining the control logic from the large language model. This can take place by the LLM in response to the instruction.

In one embodiment, the method can further comprise instructing the large language model to adapt the control logic. Thus, an iteration of the creation of the control logic by the user can take place. The user can in this respect submit change requests for the control logic to the LLM. The method in this respect provides an interface for instructing the large language model to adapt the control logic.

The control logic can have a structured logic description and/or a visualizable representation of the logic and/or an executable configuration code.

In a further development, the method can further comprise instructing the large language model to create chain-of-thought prompting information. Chain-of-thought prompting is in this respect a technique to cause the large language models to show comprehensible ways of thinking. Instead of only providing a direct answer, the LLM is encouraged to present its “thoughts” in a logical sequence, which can lead to more accurate and informed results.

In one embodiment, the large language model can comprise, be or be based on at least one of the following models: ChatGPT or Deepseek.

The object of the invention is further satisfied by an apparatus for creating a control logic of at least one component, said apparatus having the following: means for transmitting component description data to a large language model, wherein the component description data describe the at least one component; means for transmitting logic description information to the large language model, wherein the logic description information has information with respect to the control logic to be created; and means for instructing the large language model to create the control logic based on the component description data and the logic description information.

The object of the invention is further satisfied by a computer readable storage medium comprising commands that, on execution by a computer, cause it to carry out the method described herein.

Further advantageous embodiments of the method according to the invention result from the dependent claims, the drawing, and the description.

The invention will be described in the following with reference to embodiment examples and to the drawing. There are shown in schematic representations:

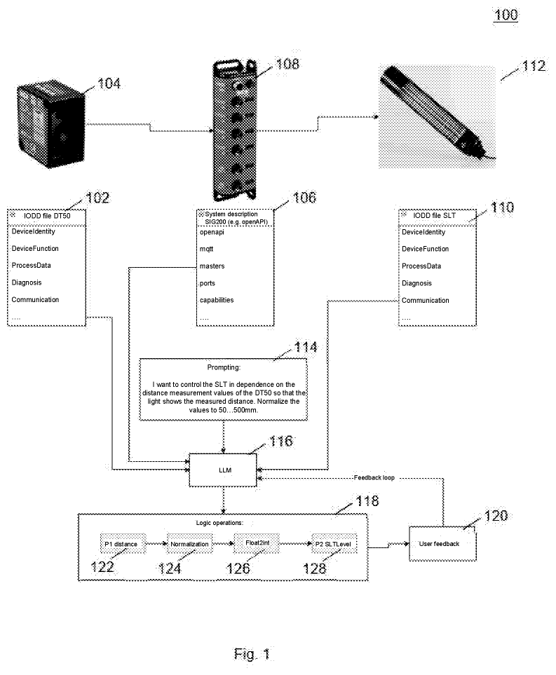

FIG. 1 a system diagram of a system for creating a logic according to an embodiment; and

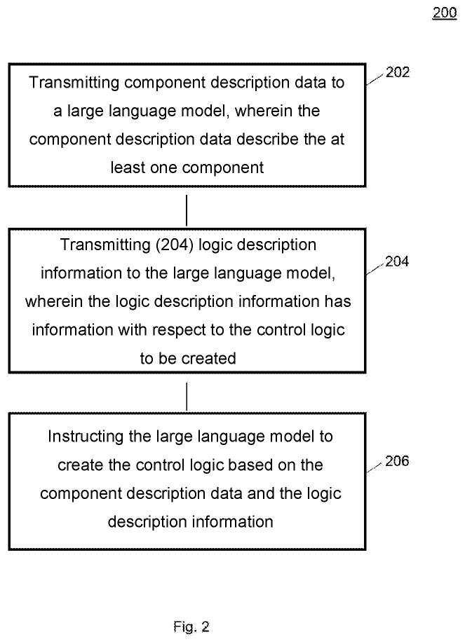

FIG. 2 a flowchart that illustrates a method for creating a control logic of at least one component according to an embodiment.

In the following, the methods and apparatus according to the invention will be explained in an exemplary manner with reference to embodiment examples.

The present invention relates to the use of a trained large language model (LLM) to take over the tasks of a logic editor in the context of IO-Link master gateways. Traditionally, a logic editor is used to configure IO-Link master gateways or the logical link is performed directly in the programmable logic controller (PLC) to create complex logical links and configuration rules that are required to control industrial automation processes. Typical logic modules that are contained in these processes comprise Boolean operations (AND, OR, NOT, XOR and others), timers, counters, comparison operators, mathematical operations and if-then conditions for the conditional execution of actions. The aim of the invention is to replace the logic editor with an LLM so that the user can formulate and execute complex logic operations by natural language input (prompting). An LLM can be specially trained for this purpose.

FIG. 1 shows a system diagram 100 of a system for creating a logic according to an embodiment. An IODD 102 of a first component 104, a system description 106 of a second component 108, and an IODD 110 of a third component 112 are transmitted to an LLM 116 together with a prompt 114. The LLM 116 generates a sequence of logic operations 118 (for example logic operations 122, 124, 126, 128) therefrom and makes them available to the user. The IODD 102, the system description 106 and the IODD 110 are examples of component descriptions. The user can provide their feedback (user feedback 120), whereby a feedback loop with the LLM 116 is created so that the LLM 116 can iteratively adjust the logic operations based on the user feedback 120.

The training process of the LLM is based on the contents of the IO Device Descriptions (IODDs), which describe what the components (for example the sensors and actuators) are capable of, and on the system description on which the LLM runs in order to know which connections exist and which interfaces are available (e.g. IT, fieldbus, IO-Link, Ethernet, digital inputs and outputs, etc.). The existing logic modules and the desired output behavior are furthermore considered. The model can be trained with a variety of sample tasks that reflect the different logical configurations, decision-making processes and control sequences. These data can comprise not only the structures of the logics themselves, but also the specific context in which these logics are used, such as sensor data processing, device communication and automation scenarios.

The training of the LLM can take place in several stages: in a basic training, followed by a domain-specific fine-tuning, and a validation and verification.

The basic training can include a basic training with general language models to ensure the natural language processing.

Domain-specific fine-tuning can include an additional training based on special IO-Link use cases and logic editor documentation.

During the validation and verification, a validation of the results by simulations and a comparison with typical tasks of the conventional logic editor can take place in order to ensure the correctness and reliability of the model.

In one embodiment, a large language model can be used, wherein only the fine-tuning is still carried out itself. Alternatively, separate LLMs can be trained, based on the basic training.

The correct implementation by the LLM can be verified by different methods. For example, this can take place by a visual representation with user feedback, wherein, based on the created logic, the user can trace whether the implementation corresponds to their idea and can confirm it via a button or correct it via drag & drop. This provides a feedback loop of the LLM for continuous improvement. Alternatively or additionally, the implementation of a simulation can take place for test purposes, wherein the implemented logic can be tested and verified based on sample data by reproducing the logic steps in a simple simulation.

The methods and apparatus according to different embodiments enable a fast implementation of applications and test logics, a fast response time to change requests, and a reduction in the effort for creating and adapting control logics. Furthermore, the user-friendliness is increased by natural language inputs, whereby users without in-depth technical knowledge can also create complex logics. The susceptibility to errors can be reduced by automated logic generation. In this respect, no additional hardware or software is required, as is the case with PLC-based solutions. A rapid adaptation and a high flexibility in the automation are made possible by the use of a trained LLM.

The different embodiments can be used for all kinds of sensors and actuators, for example, for SIMs (Sensor Integration Machines) and/or SIGs (Sensor Integration Gateways) that have provided a logic editor.

An IODD can be defined by the specification of the IOLink consortium, as can be found at https://io-link.com/share/Downloads/Package-2024-released/IO-Device-Desc-Spec_10012_V114_Jun24.zip.

For example, an IODD includes the following elements:
DocumentInfo: Includes version information, release date and copyright information;
ProfileHeader: Indicates constant information such as profile identification, profile revision and profile class ID;
ProfileBody: Describes the identity and functionality of the device;
CommNetworkProfile: Describes the communication characteristics of the device;
ExternalTextCollection: Includes language-dependent description texts;
Stamp: Includes a checksum for validation purposes to ensure that the file has not been modified;
DeviceIdentity: Includes information on the identity of the device, such as manufacturer ID and device ID;
DeviceVariantCollection: Lists different variants of the device that differ, for example, in the design or connection type;
Features: Defines specific functions of the device, e.g. whether it supports block parameter transmission;
Data TypeCollection: Includes data types that are used in the IODD, e.g. for parameters or process data;
Variables: Defines variables and their data types that are used in the device;
ProcessDataCollection: Describes the process data which the device sends or receives;
ErrorTypeCollection: Lists the error types supported by the device;
EventCollection: Defines different events which the device can trigger;
User interface: Includes menus, buttons and references to variables for the user interface;
Communication Characteristics: Defines network profiles and connection types, e.g. the type of the connectors;
Language files (optional): Supports additional languages for the IODD file so that the device can be described in several languages;
Image files (optional): Includes logos of the manufacturer and device symbols for the graphical representation;
Schema files: Ensure that the XML structure of the IODD file is correct and can be validated according to the predefined rules.

The LLM-based system according to the invention for replacing the traditional logic editor implements a structured data flow of natural language requirements into precise, executable logic configurations.

The input data to the LLM (which are transferred as prompt components to the LLM) can include the system prompt, the user prompt, and the context data.

The system prompt (which can be a constant base context) can include information about the following: available logic modules, and/or supported interfaces and data types, and/or basic system parameters.

The user prompt (which can be variable) can include information about the following: natural language description of the desired logic, and/or indication of devices, connections and conditions, and/or specification of value ranges and transformations.

The context data (which can be dynamic) can include information about the following: IODD information of the devices involved and/or gateway configuration and available resources and/or connection assignment and interface assignment.

The output data of the LLM can include a structured logic description (for example in JSON/XML format) and/or a visualizable representation for feedback/verification and/or an executable configuration code for IO-Link masters.

The input processing pipeline, i.e. the transformation of natural language descriptions into precise logic specifications, can take place in four main phases, such as are shown in

TABLE 1
Parsing and pre-analysis

| Prozessschritt | Beschreibung |
|---|---|
| Process step | Description |
| [symbol] Zerlegung | [symbol] , Aktionen und Bedingungen aus dem Text |
| Natural language | Extraction of devices, actions |
| breakdown | and conditions from the text |
| [symbol] | [symbol] |
| [symbol] | [symbol] |
| Recognition of | Identification of measurement variables, |
| key concepts | threshold values and requirements |
| [symbol] | [symbol] |
| [symbol] | [symbol] |
| Context mapping | Linking of descriptions with |
| [symbol] | known IO link device types |
| | [symbol] |
| Requirement | Classification into logic types |
| classification | (conditional, continuous, etc.) |

[symbol]

indicates data missing or illegible when filed

Tables 1, 2, 3 and 4, according to different embodiments.

TABLE 2
Semantic analysis.

| Process step | Description |
|---|---|
| Device competence | Comparison of the requirements |
| [symbol] | with IODD capabilities |
| Plausibility check | Validations of the value ranges |
| | and physical units |
| Dependency analysis | Creation of a dependency graph |
| | between data points |
| Timing analysis | Identification of time-critical |
| | operations |

[symbol]

indicates data missing or illegible when filed

TABLE 3
Logic generation.

| Process step | Description |
|---|---|
| Segmentation | Breakdown of complex requirements |
| | into atomic logic modules |
| Optimization | Summarizing of redundant operations, |
| | simplification |
| Resource allocation | Assignment of memory resources |
| | and computing resources |
| Error handling | Integration of exception handling |
| | and error checks |

TABLE 4
Formalization.

| Process step | Description |
|---|---|
| Structured model | Conversion into formal logic |
| | description (graph) |
| Serialization | Creation of structured JSON/XML |
| | representation |
| Compatibility check | Validation against gateway-specific |
| | restrictions |
| Versioning | Checking of API compatibility |

Annex 1 shows an example of a system prompt.

The context in which the LLM is used can be set in the system prompt (“You are a logic assistant for IO-Link master gateways. Your task is to translate natural language descriptions into precise logic elements.”). Furthermore, the available logic modules (“Available logic modules: . . . ”) and the available data types (“Available data types: . . . ”) can be defined. In addition, the task for the LLM can be defined (“Generate for each request: . . . ”).

Annex 2 shows an example of a user prompt. The user prompt can be entered by the user in natural language and defines what the user wants to receive. In this respect, the user can describe the desired logic by specifying the components to be used (“I want to connect a distance sensor (DT50) to port 1 and a signal light (SLT) to port 2.”) and can define the desired logic or also desired display ranges (“The signal light should display the distance measured by the sensor. The measurement range of the sensor is 0-5000 mm, but the light should only visualize values between 50-500 mm. If the distance falls below 50 mm, the light should flash red.”).

Annex 3 shows an example of a logical processing algorithm. Annex 4 shows an example of a generated logic (or logic structure) that was created for the example with the distance sensor and the signal light.

The following additional data can be used to generate the logic by means of the LLM: IODD metadata, gateway specifications and/or a logic element library.

The IODD metadata can include information about device identities and function descriptions, process data structures and data types, supported parameters and configuration options, and/or events and error messages.

The gateway specifications can include information about available hardware resources (CPU, memory), supported communication protocols, timing constraints and real-time capabilities, and/or safety features and access restrictions.

The logic element library can include the complete descriptions of all available logic modules, functional specifications with input/output parameters, performance characteristics, and/or a compatibility matrix for concatenations.

The preprocessing can include an extraction of relevant IODD data, a system context generation and/or a prompt extension.

The extraction of relevant IODD data can include an automatic evaluation of the IODD files, an identification of relevant parameters and process data, and/or a structuring of the device properties.

The system context generation can include an analysis of available interfaces and connections, a creation of a system context with connection options, and/or an integration of the master gateway functions.

The prompt extension can include a supplementation of the user prompt with structured IODD information, an addition of available variables and data types, and/or a provision of relevant constraints.

The post-processing can include a logic validation, a visualization generation and/or a configuration code generation.

The logic validation can include a check for syntactical correctness, a check for data type compatibility, and/or a recognition of potential value range overruns.

The visualization generation can include a conversion of the JSON/XML logic description into a flowchart, a color coding of different logic modules, and/or an interactive display with input/output values.

The configuration code generation can include a conversion of the logic description into executable code, a consideration of device-specific restrictions, and/or an optimization for resource efficiency.

FIG. 2 shows a flowchart 200 that illustrates a method for creating a control logic of at least one component according to an embodiment. In 202, component description data are transmitted to a large language model. The component description data describe the at least one component. In 204, logic description information is transmitted to the large language model, wherein the logic description information has information with respect to the control logic to be created. In 206, the large language model is instructed to create the control logic based on the component description data and the logic description information.

In one embodiment, the component description data are transmitted in a prompt to the large language model.

In one embodiment, the component description data are based on a device description.

In one embodiment, the input data to the LLM (which are transmitted as prompt components to the LLM) include a system prompt, a user prompt, and context data.

In one embodiment, the system prompt includes information about the following: available logic modules, and/or supported interfaces and data types, and/or basic system parameters.

In one embodiment, the user prompt includes information about the following: natural language description of the desired logic, and/or indication of devices, connections and conditions, and/or specification of value ranges and transformations.

In one embodiment, the context data include information about the following: IODD information of the devices involved, and/or gateway configuration and available resources, and/or connection assignment and interface assignment.

In one embodiment, the device description is divided into a plurality of snippets.

In one embodiment, embeddings of the plurality of snippets are calculated and the embeddings are used as component description data.

In one embodiment, information about available logic modules and/or supported interfaces and/or supported data types and/or basic system parameters is transmitted to the large language model.

In one embodiment, the logic description information is requested from a user.

In one embodiment, the logic description information describes the control logic to be created in natural language.

In one embodiment, the control logic is obtained from the large language model.

In one embodiment, the large language model is instructed to adapt the control logic.

In one embodiment, the control logic includes or is a structured logic description and/or a visualizable representation of the logic and/or an executable configuration code.

In one embodiment, the large language model is instructed to create chain-of-thought prompting information.

In one embodiment, the large language model includes or is or is based on at least one of the following models: ChatGPT or Deepseek.

### REFERENCE NUMERAL LIST

100 system diagram of a system for generating a logic according to an embodiment
102 IODD
104 first component
106 system description
108 second component
110 IODD
112 third component
114 prompt
116 LLM
118 logic operations
120 user feedback
122 logic operation
124 logic operation
126 logic operation
128 logic operation
200 flowchart that illustrates a method for creating a control logic of at least one component according to an embodiment
202 step for transmitting component description data to a large language model
204 step for transmitting logic description information to the large language model
206 step for instructing the large language model to create the control logic based on the component description data and the logic description information

### Annex 1: Example of a System Prompt

You are a logic assistant for IO-Link master gateways. Your task is to translate natural language descriptions into precise logic elements.

### Available Logic Modules:

Boolean operations: AND, OR, NOT, XOR
Mathematical operations: Addition, subtraction, multiplication, division, normalization-Comparison operators: >, <, =, >=, <=, !=
Temporal operations: Timer, delay, counter
Conversions: Float2Int, Int2Float, bit operations

### Available Interfaces in the System:

IO-Link ports: P1, P2, P3, P4, P5, P6, P7, P8
Digital inputs/outputs: DI1, DI2, DO1, DO2
Communication interfaces: MQTT, OPC UA, EtherNet/IP, PROFINET

### Available Data Types:

Integers (8-bit, 16-bit, 32-bit)
Floating point numbers (32-bit)
Boolean values
Arrays and structures according to IODD specification

### Generate for Each Request:

1. A structured logic element description in JSON format
2. A textual explanation of the implemented logic
3. A visualization of the logic steps

### Annex 2: Example of a User Prompt

I want to connect a distance sensor (DT50) to port 1 and a signal light (SLT) to port 2. The signal light should indicate the distance measured by the sensor. The measurement range of the sensor is 0-5000 mm, but the light should only visualize values between 50-500 mm. If the distance falls below 50 mm, the light should flash red.

### Annex 3: Example of a Logical Processing Algorithm

### Input: Natural Language Prompt+Context Data (IODDs, Gateway Configuration) Output:

### Formalized Logic Description

### Algorithm InputProcessing:

1. TextSegmentation (prompt) segments
2. EntityExtraction (segments, iodds) entities
   Device entities
   Measurement variable entities
   Action entities
   Conditional entities
3. RelationExtraction (entities) relationships
   Cause-effect relationships
   Transformation relationships
   Conditional relationships
4. RequirementsMapping (relationships, iodds) logical_requirements
   Matching natural language to IO-Link concepts
   Recognition of implicit requirements
   Resolution of ambiguities
5. LogicGraphCreation (logical_requirements) initial_graph
   Nodes for data sources, transformations, conditions, actions
   Edges for data flow
6. LogicOptimizationApplication (initial_graph) optimized_graph
   Elimination of redundant calculations
   Parallelization of independent operations
   Combination of consecutive transformations
7. AvailabilityCheckPerformance (optimized_graph, gateway_capabilities) validated_graph
   Checking of supported operations
   Resource utilization estimation
   Identification of limitations
8. LogicSerialization (validated_graph, target_format) formalized_logic
   Conversion to machine-readable representation
   Addition of metadata (versions, dependencies)
   Generation of documentation

Annex 4: Example of a generated logic

```
{
  “logic_steps”: [
    {
      “id”: “input_dt50”, “type”: “input”,
      “port”: “P1”,
      “data_source”: “ProcessData.PDIn.Distance”, “data_type”: “float32”,
      “description”: “Distance measurement value of DT50 sensor”
    },
    {
      “id”: “range_check”, “type”: “condition”, “input”: “input_dt50”,
      “condition”: “value < 50”,
      “description”: “Checks whether distance is below minimum
      value”
    },
    {
      “id”: “normalize”,
      “type”: “math_operation”, “operation”: “linear_scaling”, “input”: “input_dt50”,
“parameters”: {
        “input_min”: 50,
        “input_max”: 500,
        “output_min”: 0,
        “output_max”: 100,
        “clamp”: true
      },
      “description”: “Normalizes values to 0-100%” },
    {
      “id”: “convert_to_int”,
      “type”: “conversion”,
      “operation”: “float2int”,
      “input”: “normalize”,
      “description”: “Converts normalized values to integers”
    },
    {p
      “id”: “set_blinking”,
      “type”: “conditional_output”, “condition_input”: “range_check”, “true_action”:
{
        “port”: “P2”,
        “target”: “ProcessData.PDOut.VisualMode”,
“value”: 2
      },
      “false_action”: {
        “port”: “P2”,
        “target”: “ProcessData.PDOut.Level”,
“value_from”: “convert_to_int”
      },
      “description”: “Sets flashing mode or filling level value” }
  ]
}
```

1. A method for creating a control logic of at least one component, the method comprising:
transmitting component description data to a large language model, wherein the component description data describe the at least one component;
transmitting logic description information to the large language model, wherein the logic description information has information with respect to the control logic to be created; and
instructing the large language model to create the control logic based on the component description data and the logic description information.

2. The method according to claim 1,
wherein the component description data are transmitted in a prompt to the large language model.

3. The method according to claim 1,
wherein the component description data are based on a device description.

4. The method according to claim 3, further comprising:
splitting the device description into a plurality of snippets.

5. The method according to claim 4, further comprising:
calculating embeddings of the plurality of snippets; and
using the embeddings as component description data.

6. The method according to claim 1, further comprising:
transmitting information about available logic modules and/or supported interfaces and/or supported data types and/or basic system parameters to the large language model.

7. The method according to claim 1, further comprising:
requesting the logic description information from a user.

8. The method according to claim 7,
wherein the logic description information describes the control logic to be created in natural language.

9. The method according to claim 1, further comprising:
obtaining the control logic from the large language model.

10. The method according to claim 9, further comprising
instructing the large language model to adapt the control logic.

11. The method according to claim 1,
wherein the control logic has a structured logic description and/or a visualizable representation of the logic and/or an executable configuration code.

12. The method according to claim 1, further comprising:
instructing the large language model to create chain-of-thought prompting information.

13. The method according to claim 1,
wherein the large language model has or is based on at least one of the following models: ChatGPT or Deepseek.

14. An apparatus for creating a control logic of at least one component, the apparatus comprising:
means for transmitting component description data to a large language model, wherein the component description data describe the at least one component;
means for transmitting logic description information to the large language model, wherein the logic description information has information with respect to the control logic to be created; and
means for instructing the large language model to create the control logic based on the component description data and the logic description information.

15. A computer readable storage medium comprising commands that, on execution by a computer, cause it to carry out the method according to claim 1.
